(19) United States
(12) Patent Application Publication
(10) Pub. No.: US 2007/0290009 A1
(43) Pub. Date: Dec. 20, 2007

(54) Plastic closure for a glass vessel

(76) Inventor: Dieter Fuchs, Dissen (DE)

Correspondence Address: JOHN S. PRATT, ESQ;KILPATRICK STOCKTON, LLP, 1100 PEACHTREE STREET, ATLANTA, GA, 30309, US

(21) Appl. No.: 11/455,562

(22) Filed: Jun. 19, 2006

(51) Int. Cl. B67D 3/00; A47G 19/24

(52) U.S. Cl. 222/480; 222/565

(57) ABSTRACT

The present invention relates to a plastic closure for a glass vessel, comprising a ring-shaped top with an outside surface and an inside surface, optionally with a plastic base area, which is arranged perpendicularly the to the ring shape and which has at least one opening, optionally a scattering disc that can be inserted into the ring-shaped top; and a lid, characterised in that the ring-shaped top has a peripheral projection on its lower outside surface and a peripheral centring ridge is provided on said projection, resting on the upper outside surface, the optional scattering disc has a peripheral side wall and is subdivided into at least two compartments by at least one partitioning wall, which is the same height as the side wall, it being possible to provide openings in the floors of the compartments, which openings may optionally be of different sizes and/or of the same size and in different numbers, and wherein the lid has an inner planar insert which, when the lid is closed with the ring-shaped top, forms a flush seal with the side and partitioning walls of the scattering disc.

The present invention relates to a plastic closure for a glass vessel, comprising a ring-shaped top with an outside surface and an inside surface, optionally with a plastic base area which is arranged perpendicularly to the ring shape and which has at least one opening; optionally a scattering disc that can be inserted into the ring-shaped top; and a lid.

Plastic closures of the generic kind are already known in the state of the art. Spice containers, for example, are known, which consist of a glass vessel which is sealed by a plastic closure. As a rule, a plastic closure of this kind is constructed from a ring-shaped top which makes it possible to connect the closure to the glass vessel, by means of a thread for example. It is regularly the case in the state of the art that a scattering disc can be inserted into a ring-shaped top of this kind, i.e. a device by means of which, as desired, spices or the like can be dispensed in varying quantities because of differently sized openings in the floor of the scattering disc. Finally, a lid is provided which, likewise by means of a thread for example, can be screwed onto the ring-shaped top.

In the plastic closures of the generic kind, it has proven to be disadvantageous that a stable seal, especially an air-tight one, between the lid and the ring-shaped top is often not possible, because the lid is arranged not centrally, but slightly crookedly, on said top, as a result of which a slight leakage may result. Furthermore, it is often possible, with the plastic closures according to the state of the art that, when a scattering disc with a plurality of compartments is present, contents to be dispensed from the glass vessel, such as spices, can enter the different compartments as a consequence of the fact that partitioning walls to form the compartments are not sufficiently high and do not form a flush seal with the lid.

The present invention is based on the problem of improving the generic type of plastic closure in such a way that the disadvantages of the prior art are overcome. In particular, it is intended to provide a plastic closure that enables a secure closure to be achieved between the lid and the ring-shaped top and which, when a scattering disc is present, makes it possible for the contents of the vessel to be dispensed simply and reliably via the openings in the floor of the individual compartments of the scattering disc.

The problem is solved in accordance with the invention in that the ring-shaped top has a peripheral projection on its lower outside surface and a peripheral centring ridge is provided on this projection, resting on the upper outside surface, the optional scattering disc has a peripheral side wall and is subdivided into at least two compartments by at least one partitioning wall which is the same height as the side wall, it being possible to provide openings in the floors of the compartments, which openings may optionally be of different sizes and/or of the same size and in different numbers; and the lid has an inner planar insert which, when the lid is closed with the ring-shaped top, forms a flush seal with the side and partitioning walls of the scattering disc.

In this connection, it is preferred that radial transverse ribs spaced apart from one another should be arranged on the underside of the plastic base area.

It may also be provided that a thread is provided on the outside surface of the ring-shaped top above the centring ridge.

The lid may likewise have an internal thread.

In one embodiment, the plastic base area has a further, central opening.

It is also preferred that the scattering disc has snap-in pins extending from its underside, preferably to snap into the further central opening in the plastic base area.

It is particularly preferred that the scattering disc should have five compartments, each of which has no or varying numbers of differently sized openings in the floor.

Finally, the ring-shaped top, the scattering disc and the lid are preferably manufactured from an injection-moulded thermoplastic plastics material.

It has surprisingly been found in accordance with the invention that the plastic closure known from the state of the art can be improved by three essential measures. First of all, a centring ridge is provided on the outside surface of the ring-shaped top, resting on the region of the peripheral projection and the upper outside surface. Thanks to this centring ridge, it is possible to arrange the lid on the ring-shaped top in such a way that the opening in the vessel can be provided with a secure, firm and substantially air-tight seal. Secondly, the fact that the peripheral side wall is the same height as the partitioning wall or partitioning walls results in the situation that, in use, the contents to be dispensed from the glass vessel are merely dispensed via one compartment and their distribution over a number of compartments is avoided. Finally, in accordance with the invention, the lid of the plastic closure has an inner planar insert, which terminates flush with the faces of the side and partitioning walls, which likewise ensures that contents of the vessel to be dispensed are distributed over the scattering disc or the plastic closure as a whole.

A further preferred embodiment of the plastic closure of the invention results from the fact that radial transverse ribs spaced apart from one another are arranged on the underside of the base area, which considerably improve the stability of the ring-shaped top.

Further benefits and features of the invention will become apparent from the following detailed description of preferred embodiments, in combination with the attached drawings, in which:

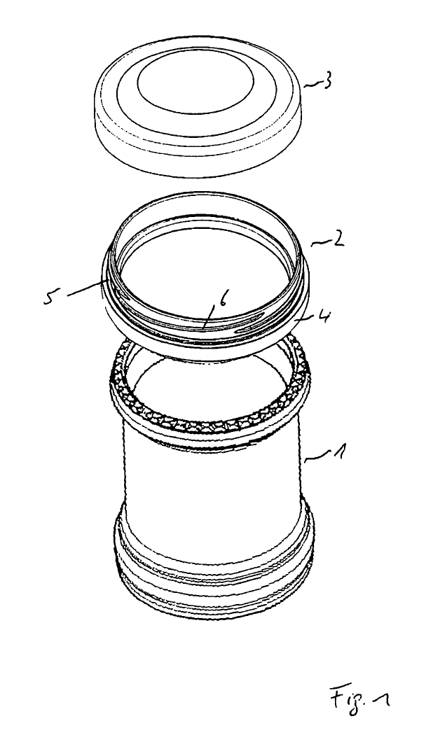

FIG. 1 shows an exploded view of a glass vessel with a plastic closure in accordance with the invention;

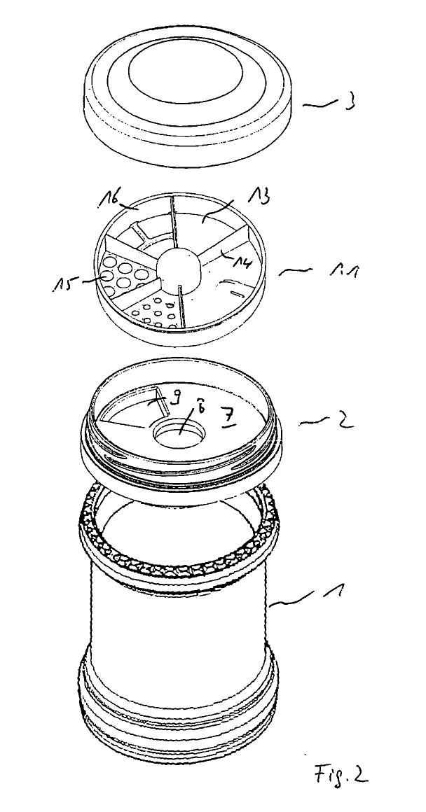

FIG. 2 shows an exploded view, similar to FIG. 1, of a glass vessel and a plastic closure in accordance with the invention, though with an integrated scattering disc;

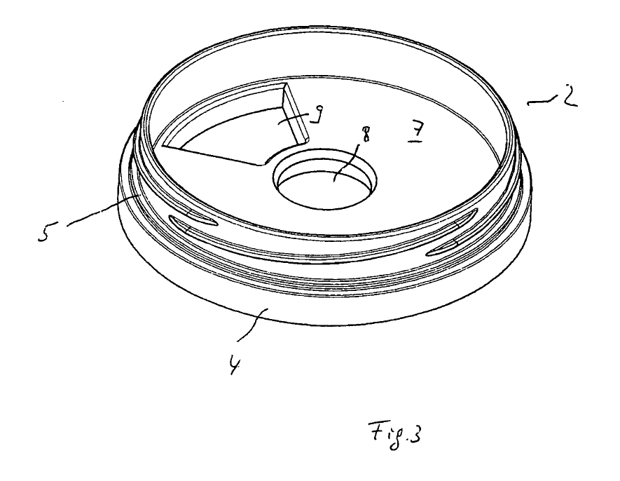

FIG. 3 shows a ring-shaped top in an enlarged view;

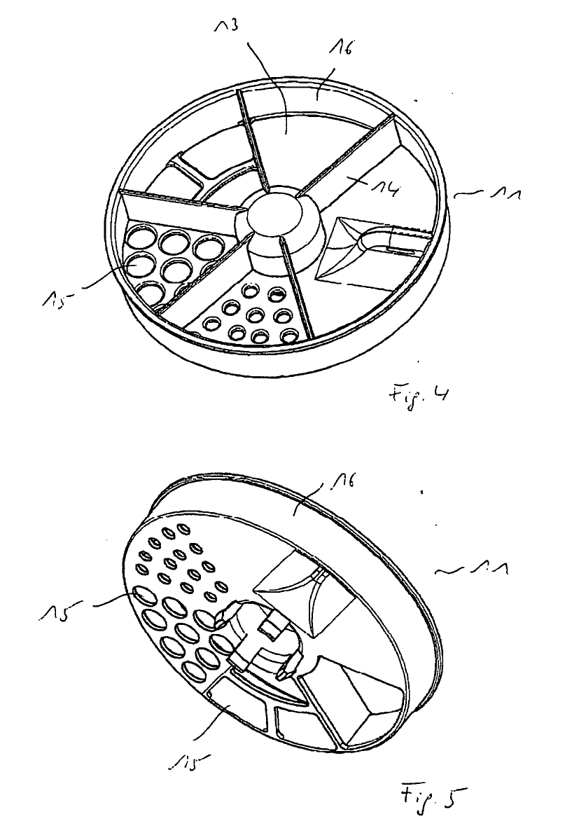

FIG. 4 shows a perspective view of a top side of a scattering disc for the plastic closure of the invention; and

FIG. 5 shows a perspective view of an underside of the scattering disc shown in FIG. 4.

FIG. 1 shows an exploded view of a glass vessel 1 and a plastic closure in accordance with the invention, which consists of a ring-shaped top 2 and a lid 3. The ring-shaped top 2 can be connected to the glass vessel 1 by any means desired, preferably via a snap-in or threaded connection. As can be seen in greater detail in FIG. 3, the ring-shaped top 2 has a peripheral projection 4 in the lower portion on the outer surface. A centring ridge 5 is provided resting on this projection 4 and on the upper outside surface. Finally the upper part of the outside surface has a thread 6. The lid has a corresponding thread on its internal side wall (not shown), so that the lid can be screwed onto the ring-shaped top 2. When the lid 3 is screwed onto the ring-shaped top 2, the centring ridge 5 aligns the lid 3 in such a way that it can be screwed on in a centred manner, as a result of which leakages, jamming, etc. can be avoided.

The construction shown in FIG. 2 is similar to the one in FIG. 1, the same reference numerals being used for the same components. The ring-shaped top 2 in FIG. 2 now additionally has a plastic base area 7, which is provided with a central round opening 8 and an outer angular opening 9. Snap-in pins 10 of a scattering disc 11 can snap into the central opening 8, as is apparent from FIG. 5. The snap-in pins 10 shown there have projections 12 extending outwards in their lower part, which can snap in behind the central opening 8 of the ring-shaped top 2 when the scattering disc 11 is pressed in, for example in the central opening 8. The scattering disc 11 shown in FIG. 2 has a peripheral side wall 16 and a total of five compartments 13, which are each separated from one another by partitioning walls 14. Two compartments 13 do not have any openings in the floor, while three compartments 13 have openings in the floor 15 of different dimensions and numbers, so that different quantities of the contents of the vessel can be dispensed. In the process, the scattering disc 11 can be turned in such a way that any compartment 13 desired lies one on top of the other with the angular opening 9. It is consequently preferred that the angular opening 9 should have similar dimensions to each of the compartments 13.

The lid 3 of FIG. 2 is again provided with a thread, so that it can be screwed onto the ring-shaped top 2, using the centring ridge 5. In addition, the lid 3 of FIG. 2 (like the lid of FIG. 1) has an inner planar insert (not shown) which, when the lid 3 is closed, forms a flush seal with the ring-shaped top 2 and/or with the faces of the side and partitioning walls 14, so that, in that case, there can be no passageway between the underside of the lid and the face of the side and partitioning walls 14. The advantage of this is that, for example, when a glass vessel with the closure according to the invention is being transported, contents of the vessel are prevented from being distributed over several compartments 13 of the scattering disc 11 or over the plastic closure in general.

The features of the invention disclosed in the above description, in the claims and in the drawings can be essential to implementing the invention in its various embodiments both individually and in any combination.

1. A plastic closure for a glass vessel (1), comprising:
a ring-shaped top (2) with an outside surface and an inside surface, optionally with a plastic base area (7) which is arranged perpendicularly to the ring shape and which has at least one opening (9); optionally a scattering disc (11) that can be inserted into the ring-shaped top (2); and a lid (3), characterised in that the ring-shaped top (2) has a peripheral projection (4) on its lower outside surface and a peripheral centring ridge (5) is provided on said projection (4), resting on the upper outside surface, the optional scattering disc (11) has a peripheral side wall (16) and is subdivided into at least two compartments (13) by at least one partitioning wall (14) which is the same height as the side wall (16), it being possible to provide openings in the floors (15) of the compartments (13), which openings may optionally be of different sizes and/or of the same size and in different numbers, and wherein the lid (3) has an inner planar insert which, when the lid (3) is closed with the ring-shaped top (2), forms a flush seal with the side and partitioning walls (16, 14) of the scattering disc (11).

2. The closure as claimed in claim 1, characterised in that radial transverse ribs spaced apart from one another are arranged on the underside of the plastic base area (7).

3. The closure as claimed in claim 1, characterised in that a thread (6) is provided on the outside surface of the ring-shaped top (2) above the centring ridge (5).

4. The closure as claimed in claim 1, characterised in that the lid (3) has an internal thread.

5. The closure as claimed in claim 1, characterised in that the plastic base area (7) has a further, central opening (8).

6. The closure as claimed in claim 1, characterised in that the scattering disc (11) has snap-in pins (10) extending from its underside, preferably to snap into the further central opening (8) of the plastic base area (7).

7. The closure as claimed in claim 1, characterised in that the scattering disc (11) has five compartments (13), each of which has no or differently sized openings in the floor (15), in varying numbers in each case.

8. The closure as claimed in claim 1, characterised in that the ring-shaped top (2), the scattering disc (11) and the lid (3) are manufactured from an injection-moulded thermoplastic plastics material.
